(19) United States
(12) Patent Application Publication
(10) Pub. No.: US 2024/0103926 A1
(43) Pub. Date: Mar. 28, 2024

(54) SYSTEMS AND METHODS FOR MANAGING AUTOSCALED USER SPACE NETWORKING STACK

(71) Applicant: Citrix Systems, Inc., Fort Lauderdale, FL (US)

(72) Inventors: Mohit Prakash Saxena, Bangalore (IN); Harihara Sudhan, Bangalore (IN); Nagesh Mallappa, Bangalore (IN)

(21) Appl. No.: 17/955,277

(22) Filed: Sep. 28, 2022

(51) Int. Cl. G06F 9/50; G06F 9/54

(52) U.S. Cl. CPC G06F 9/505; G06F 9/545; G06F 9/546

(57) ABSTRACT

Managing an autoscaled user space networking stack is provided. A cluster of containers are disposed in a userspace separate from a kernel space of a device. Each container in the cluster of containers can execute a respective one of a plurality of virtual functions, for a network interface card of the device, to cause packets received by the device to bypass the kernel space. The device can forward, via a load balancing technique, a packet received by the device to a container in the cluster of containers. The container can execute a virtual function of the plurality of virtual functions. The device can update a queue for a core managed by the virtual function. The update can cause the core to process the packet in accordance with the queue.

### FIELD OF THE DISCLOSURE

This application generally relates to monitoring and controlling network interfaces, including but not limited to systems and methods for attachments to one or more network interfaces by a cluster of containers.

### BACKGROUND

A performance of a network device can vary based on parameters of the device. For example, central processor unit (“CPU”) load or speed, memory bandwidth, network interface bandwidth, driver implementations or other constraints can affect device performance. Multi-core or multi-CPU devices can scale to increase performance. However, performance may not scale linearly with the addition of cores. For example, a balancing overhead such as load balancing or process scheduling between the cores can require a higher overhead for a resource of the device.

### SUMMARY

This Summary is provided to introduce a selection of concepts in a simplified form that are further described below in the Detailed Description. This Summary is not intended to identify key features or essential features, nor is it intended to limit the scope of the claims included herewith.

Computer applications or other resources can be provided to a client computing device by a remote device. For example, a data center can include one or more devices (e.g., servers) each of which may host one or more services that together can form a software application or service. A controller can host various applications to deliver resources, referred to as application delivery controllers (“ADC”) herein. A container can be instantiated to host one or more ADC. For example, each container can include a scalable, selectable, or predefined number of cores. Multiple instances of a container hosting a same resource can be clustered together, such that a load balancer can independently balance a load between or within the containers (e.g., in a hierarchical implementation). Such an approach can reduce a load balancing overhead. For example, 512 cores of a processor can be assigned to 32 containers, each container having 16 cores. A load balancer can thereafter balance a load between the 32 containers or the 16 cores thereof, rather than 512 individual cores, which may reduce an overhead and may, in turn reduce device power use, increase performance, or reduce a required number of cores.

Each container can interface with a network interface, such as a network interface card or port. The network interface can be managed by a connected device. For example, a driver for the network card can operate in kernel space, as a component of an operating system. The driver can thus be limited by a kernel performance such as memory or CPU limitations thereof, or implementations of the driver itself. It may therefore be desirable to instantiate a connection to the interface in the user space of a device. For example, a plurality of virtual interfaces for a controller can be instantiated, wherein each ADC or container can include a virtual interface, and each processor thereof can be assigned a queue. Moreover, the various containers can be aggregated as a cluster, such that for some purposes, the cluster can be addressable to a remote device. Thus, the clusters of containers can benefit from a reduced overhead, and an implementation which allows at least some systems in communicative connection with the device to abstract any complexity thereof to view the cluster as an atomic resource.

An aspect of this disclosure provides a system. The system includes a device having multiple cores and at least one memory. The device can maintain a cluster of containers in a user space separate from a kernel space of the device. Each container in the cluster of containers can execute a respective virtual function for a network interface card of the device. The device can be configured to cause packets received by the device to bypass the kernel space. The device can forward, via a load balancing technique, a packet received by the device to a container in the cluster of containers. The packed can be forwarded in the user space that executes a virtual function of the plurality of virtual functions. The device can update a queue for a core of the cores managed by the virtual function to cause the core to process the packet in accordance with the queue.

In some embodiments, the device is configured to identify a number of cores accessible to the device to process packets received by the device. In some embodiments, the device is configured to determine, a predetermined number of containers for the plurality of virtual functions to establish. The determination can be responsive to the number of cores greater than a threshold. In some embodiments, the device is configured to configure, based on the number of cores, each of the plurality of virtual functions with a predetermined number of queues. Each queue of the predetermined number of queues can maps to a core of the plurality of cores.

In some embodiments, the device is configured to identify a configuration file established for the device. The configuration file can include an indication of a number of cores of the device, an auto-scale factor, a scale-up threshold, and a scale down threshold.

In some embodiments, the device includes a daemon executed by the device in the user space. The daemon can be configured to split the network interface card of the device into the plurality of virtual functions. The daemon can be configured to configure a plurality of containers of the cluster of containers with a respective one of the plurality of virtual functions. The configuration can cause packets received by the device to bypass the kernel space and be processed by at least one of the plurality of virtual functions configured in the plurality of containers.

In some embodiments, the device is configured to identify, in a configuration file established for the device, a number of cores accessible to the device and an indication to auto-scale. In some embodiments, the device is configured to invoke, responsive to the indication to auto-scale and the number of cores greater than a threshold, the daemon.

In some embodiments, the device is configured to invoke a daemon configured to determine a number of virtual functions operable with the network interface card of the device, a number of threads operable by each virtual function, and a maximum number of containers operable within the cluster of containers. The invocation can be responsive to one or more parameters indicated in a configuration file established for the device. In some embodiments, the device is configured to determine a number of cores the daemon is capable to support based on the number of virtual functions, the number of threads, and the maximum number of containers. In some embodiments, the device is configured to establish, based on a comparison of the determined number of cores the daemon is capable to support with a number of cores accessible by the device, the cluster of containers.

In some embodiments, the containers within the cluster of containers communicate via an internal bridge network that is not directly accessible via a public network, and the device is further configured to assign an internet protocol address to the cluster of containers.

In some embodiments, the device is configured to identify a utilization of a first plurality of cores managed by the plurality of virtual functions. In some embodiments, the device is configured to determine, responsive to the utilization greater than or equal to a threshold, to upscale the cluster of containers. In some embodiments, the device is configured to invoke, responsive to the determination to upscale the cluster of containers, an additional container with an additional virtual function for an additional core of the plurality of cores. In some embodiments, the device is configured to add the additional container to the cluster of containers.

In some embodiments, the device is configured to identify a utilization of the plurality of cores managed by the plurality of virtual functions. In some embodiments, the device is configured to determine, responsive to the utilization less than or equal to a threshold, to downscale the cluster of containers. In some embodiments, the device is configured to cause removal of at least one container from the cluster of containers to reduce a number of containers in the cluster of containers.

In some embodiments, the device is configured to detect an error associated with the container or the virtual function in the cluster of containers. In some embodiments, the device is configured to replace, responsive to detection of the error, the container with a new container and a new virtual function to manage the core.

In some embodiments, the device is configured to detect an error associated with the container or the virtual function in the cluster of containers. In some embodiments, the device is configured to include the error in a log for the container. In some embodiments, the device is configured to provide the log to a technical support device remote from the device.

In some embodiments, the device is configured to store, in a log, an indication of an error associated with the container or the virtual function in the cluster of containers. In some embodiments, the device is configured to provide the log to a technical support device remote from the device. In some embodiments, the device is configured to cause removal of the container from the cluster of containers. The removal can be responsive to the error and subsequent to provision of the log to the technical support device.

Another aspect of this disclosure provides a method. The method can be performed by a device. The method can include maintaining, by a device comprising a plurality of cores and memory, a cluster of containers in a user space separate from a kernel space of the device. Each container in the cluster of containers can execute a respective one of a plurality of virtual functions, for a network interface card of the device, configured to cause packets received by the device to bypass the kernel space. The method can include forwarding a packet received by the device to a container in the cluster of containers in the user space that executes a virtual function of the plurality of virtual functions. The forwarding can be performed via a load balancing technique. The method can include updating a queue for a core of the plurality of cores managed by the virtual function to cause the core to process the packet in accordance with the queue.

In some embodiments, the method can include identifying a number of cores accessible to the device to process packets received by the device. In some embodiments, the method can include determining responsive to the number of cores greater than a threshold, to establish a predetermined number of containers for the plurality of virtual functions. In some embodiments, the method can include configuring, based on the number of cores, each of the plurality of virtual functions with a predetermined number of queues. Each queue of the predetermined number of queues can map to a core of the plurality of cores.

In some embodiments, the method can include identifying a configuration file established for the device, the configuration file comprising an indication of a number of cores of the device, an auto-scale factor, a scale-up threshold, and a scale down threshold.

In some embodiments, the method can include splitting, by a daemon executed by the device in the user space, the network interface card of the device into the plurality of virtual functions. In some embodiments, the method can include configuring, by the daemon, a plurality of containers of the cluster of containers with a respective one of the plurality of virtual functions to cause packets received by the device to bypass the kernel space and be processed by at least one of the plurality of virtual functions configured in the plurality of containers.

In some embodiments, the method can include identifying, in a configuration file established for the device, a number of cores accessible to the device and an indication to auto-scale. In some embodiments, the method can include invoking, responsive to the indication to auto-scale and the number of cores greater than a threshold, the daemon.

In some embodiments, the method can include invoking a daemon configured to determine a number of virtual functions operable with the network interface card of the device, a number of threads operable by each virtual function, and a maximum number of containers operable within the cluster of containers. The invocation can be responsive to one or more parameters indicated in a configuration file established for the device. In some embodiments, the method can include determining a number of cores the daemon is capable to support based on the number of virtual functions, the number of threads, and the maximum number of containers. In some embodiments, the method can include establishing, based on a comparison of the determined number of cores the daemon is capable to support with a number of cores accessible by the device, the cluster of containers.

Another aspect of this disclosure provides a non-transitory computer-readable medium storing instructions. The instruction can cause a processor to maintain a cluster of containers in a user space separate from a kernel space of a device. Each container in the cluster of containers can execute a respective one of a plurality of virtual functions, for a network interface card of the device, configured to cause packets received by the device to bypass the kernel space. The instruction can cause a processor to forward, via a load balancing technique, a packet received by the device to a container in the cluster of containers in the user space that executes a virtual function of the plurality of virtual functions. The instruction can cause a processor to update a queue for a processor managed by the virtual function to cause the processor to process the packet in accordance with the queue.

In some embodiments, the instructions can cause a processor to identify a number of processors accessible to the device to process packets received by the device. In some embodiments, the instructions can cause a processor to determine, responsive to the number of processors greater than a threshold, to establish a predetermined number of containers for the plurality of virtual functions. In some embodiments, the instructions can cause a processor to configure, based on the number of cores, each of the plurality of virtual functions with a predetermined number of queues. Each queue of the predetermined number of queues can map to a processor of the number of processors.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of a data processing system, in accordance with an illustrative embodiment;

FIG. 6 is a block diagram of a host device, in accordance with an illustrative embodiment;

FIG. 7 is a memory map for a host device, in accordance with an illustrative embodiment;

FIGS. 8A and 8B are flow diagrams of methods for autoscaling user space network stacks, in accordance with an illustrative embodiment; and

FIG. 9 is a flow diagram of a method for autoscaling user space network stacks, according to an illustrative embodiment.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein;
Section B describes an appliance architecture;
Section C describes embodiments of systems and methods for virtualizing an application delivery controller;
Section D describes embodiments of systems and methods for providing a clustered appliance architecture environment;
Section E describes systems and methods for autoscaled user space networking stacks; and
Section F describes embodiments of systems and methods for autoscaled user space networking stacks.

### A. Network and Computing Environment

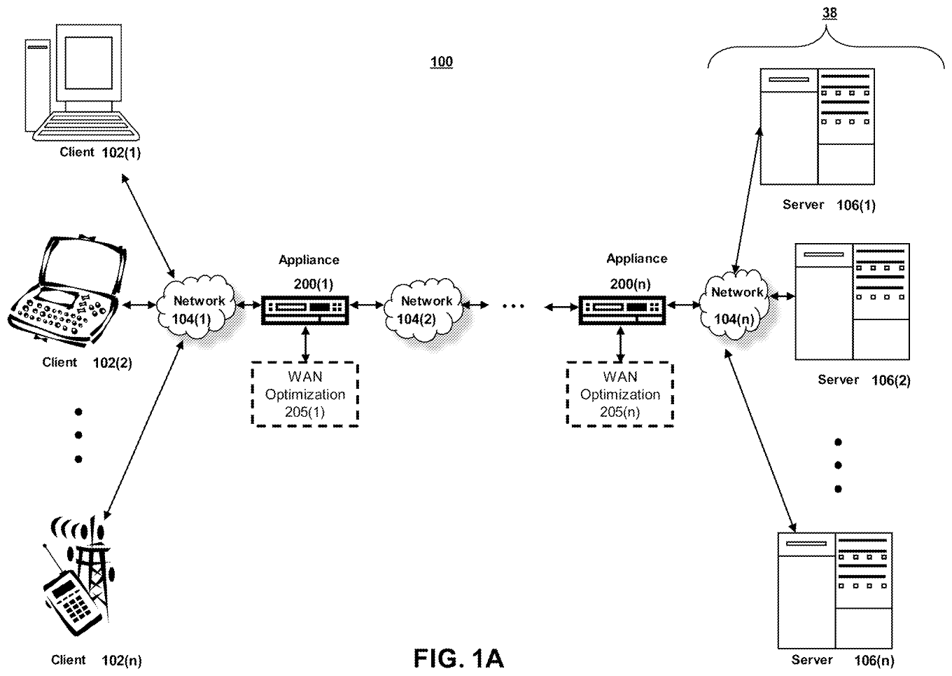

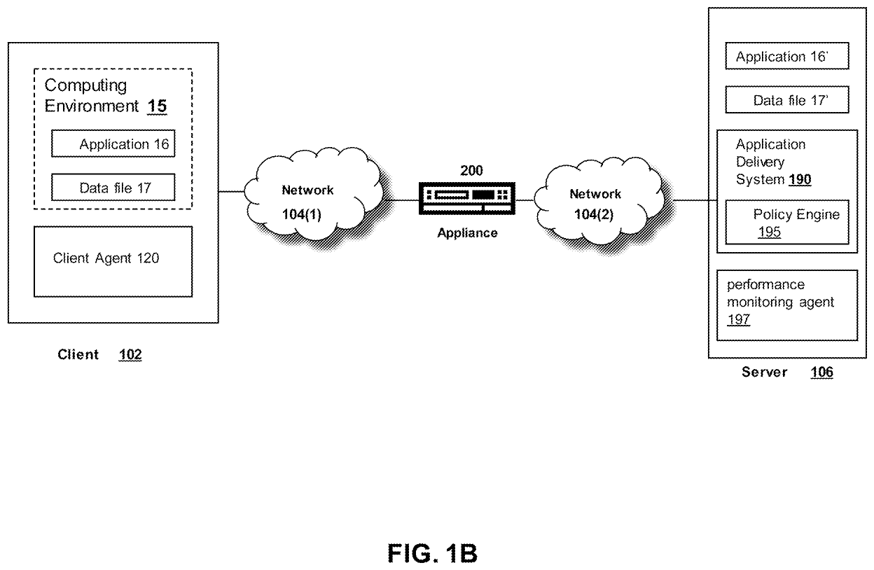

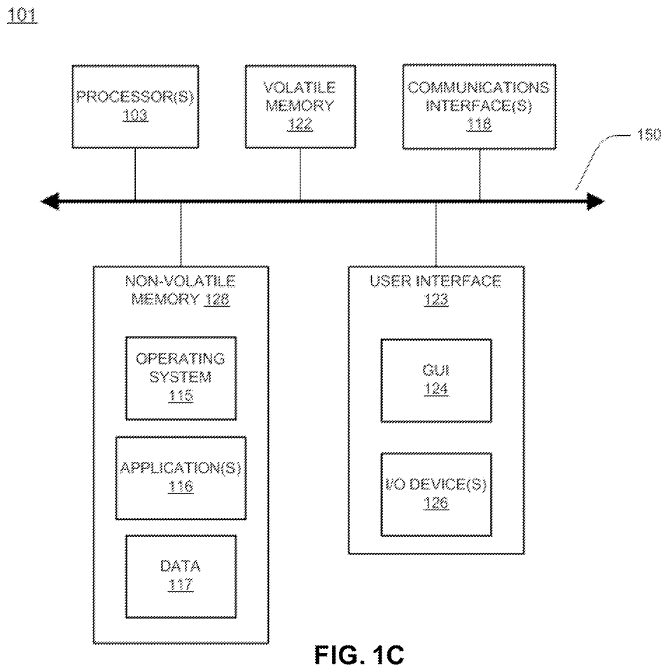

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

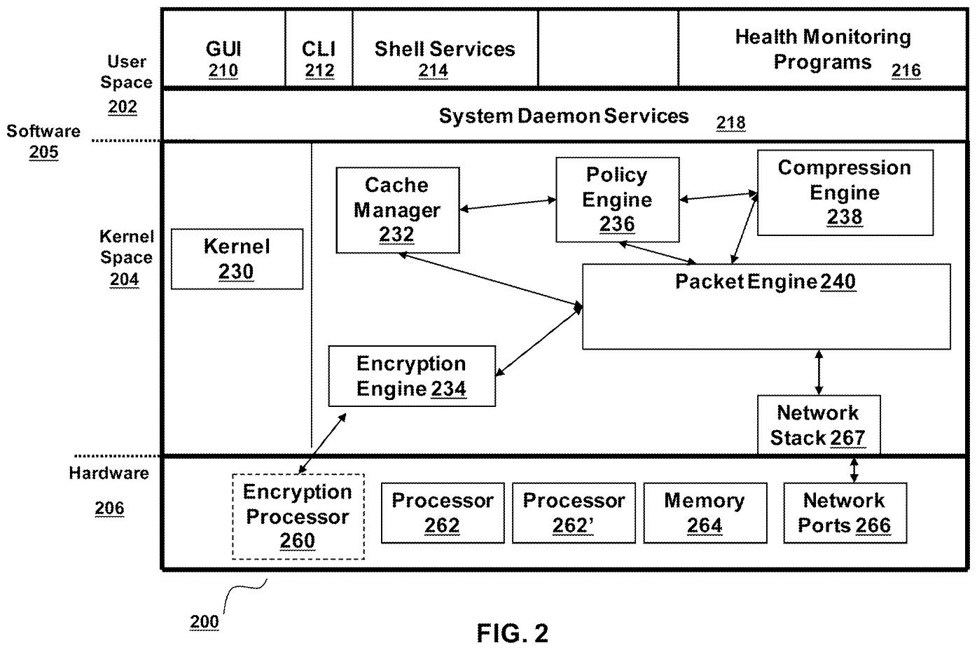

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

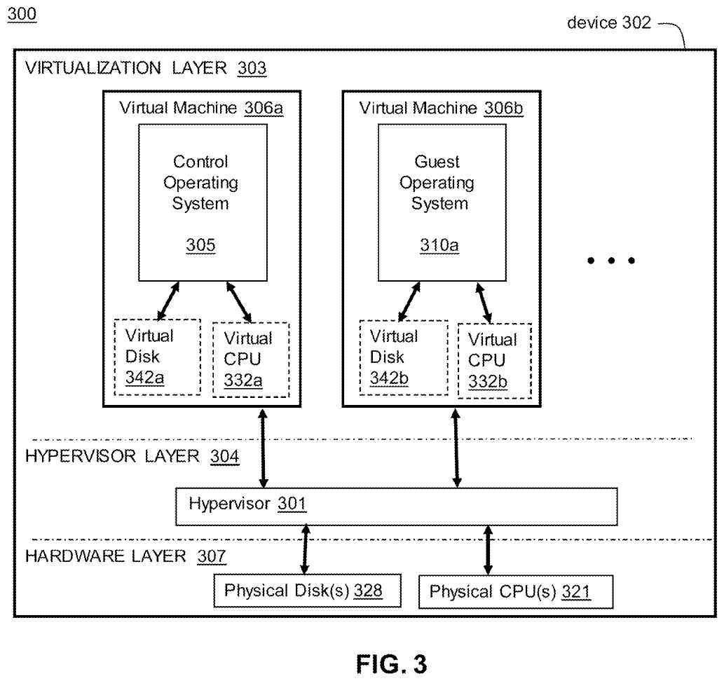

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

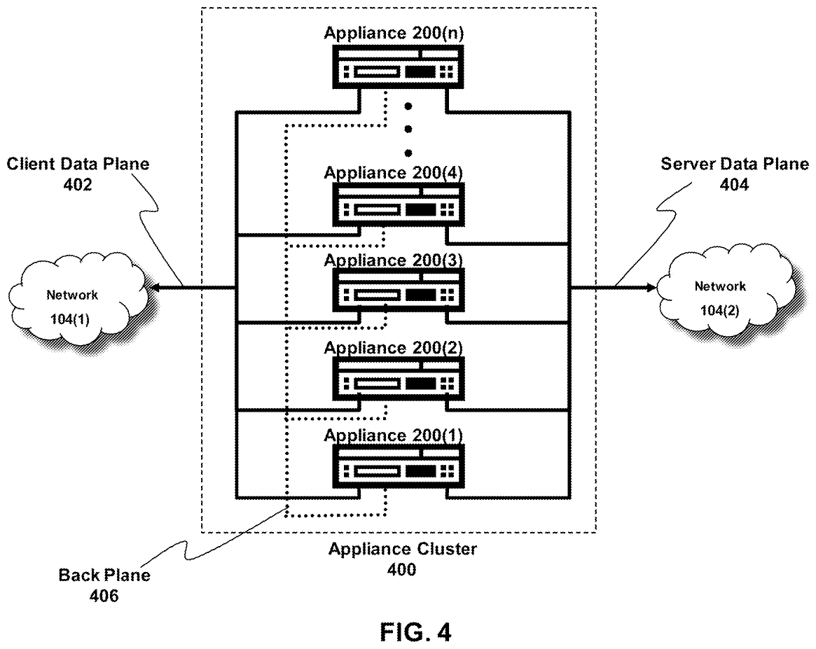

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a first network 104(1) via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104(2) via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Autoscaled User Space Networking Stacks

A kernel space network driver can inherit one or more limitations or structures from the kernel. For example, a memory allocation or multi-core scaling performance can limit a performance of a kernel space network driver which can limit a memory capacity or core count of a device. A user space network driver can bypass the kernel space network driver. The user space network driver can expose one or more virtual interfaces to one or more clusters of containers. Each container can include one or more cores, each of which can be assigned to a queue of the virtual interface.

The clusters can increase or decrease a number of containers responsive to a load of the containers. For example, the number of clusters can scale up in response to a high CPU use, or scale down in response to a low CPU use. Cores of the scaled down clusters can be reassigned to other clusters or purposes or idled. A load balancer can balance a load of the containers by selectively routing packets between the containers of the cluster. The load balancer can send the packets to queues of the respective clusters, at a virtual interface assigned to each cluster. The containers can be monitored, migrated, or supported by a technical support device. For example, the technical support device can collect data or restore container instances.

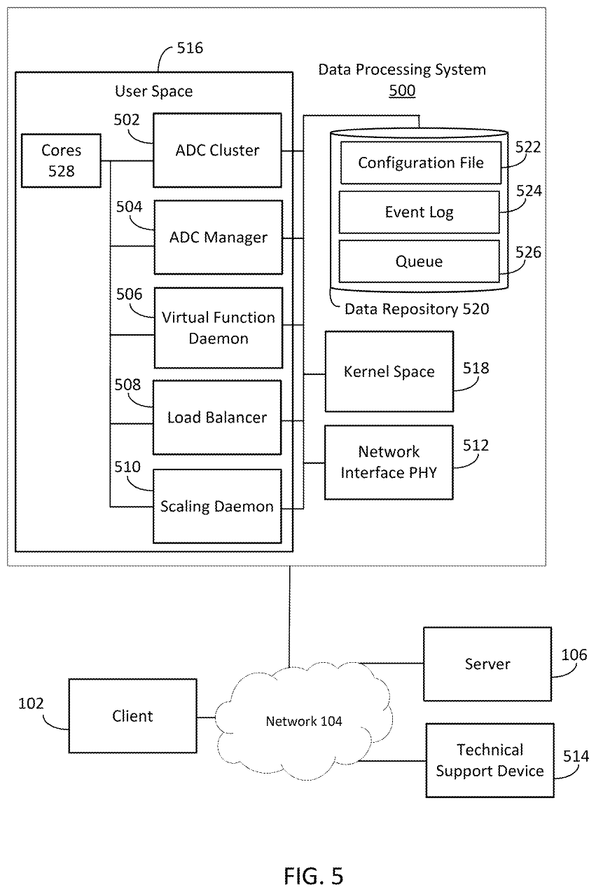

FIG. 5 is a block diagram of a data processing system 500, in accordance with an illustrative embodiment. The data processing system 500 can manage autoscaled user space networking stacks. The data processing system 500 can communicate via a network 104. The network 104 can include computer networks 104 such as the Internet, local, wide, metro, or other area networks 104, intranets, cellular networks, satellite networks, peripheral component interconnect express (“PCIe”) networks, and other communication networks 104 such as voice or data mobile telephone networks 104. The network 104 can be public or private. Various components of the data processing system 500 can be disposed within one or more private network 104, and can communicate with devices over public networks 104.

The data processing system 500 can include at least one ADC cluster 502, ADC manager 504, virtual function daemon 506, load balancer 508, scaling daemon 510, network interface physical layer device (“PHY”) 512, technical support device 514, or data repository 520. The ADC cluster 502, ADC manager 504, virtual function daemon 506, load balancer 508, scaling daemon 510, network interface PHY 512, or technical support device 514 can each include at least one processing unit or other logic device such as a programmable logic array engine, or module configured to communicate with the data repository 520 or database. The ADC cluster 502, ADC manager 504, virtual function daemon 506, load balancer 508, scaling daemon 510, network interface PHY 512, or technical support device 514 can be separate components, a single component, or part of the data processing system 500, or a host device thereof.

The data processing system 500 can include one or more contiguous or non-contiguous user spaces 516 or kernel spaces 518. According to various embodiments, the other components of the data processing system can reside in, be called by, access, or interface with the user spaces 516 or kernel spaces 518. The data processing system 500 can include hardware elements, such as one or more processors, logic devices, or circuits. The data processing system 500 can include one or more components or structures of functionality of computing devices depicted in FIG. 1C. For example, the data processing system 500 can include one or more multi-core processors, wherein one or more cores 528 of the multi-core processor can be associated with (e.g., assigned to a thread of) the various components of the data processing system 500.

The data repository 520 can include one or more local or distributed databases, and can include a database management system. The data repository 520 can include computer data storage or memory. The data repository 520 can be configured to store one or more of configuration files 522, event logs 524, or queues 526. The configuration files 522 can include a number of threads or cores 528 available or a maximum number of cores 528 or threads to instantiate. The configuration files 522 can include a scale up factor, such as an indication to instantiate an additional ADC or container instance based on a CPU load (e.g., exceeding 95% load). The configuration files 522 can include a scale a scale down factor, such as an indication to reduce a number of instances based on a scale factor (e.g., less than 25% load wherein at least two instances are active). The configuration files 522 can include a scale factor, such as a number of instances to instantiate or reduce, responsive to a scale up or scale down threshold being reached (e.g., one or more instances). The event log 524 can include indications of activity of various instances such as instantiations or reductions of instances, errors suffered by instances, or activity performed by instances (e.g., activity associated with or proximate to errors). The queues 526 can include a memory space in a user space 516 of the data processing system, or a buffer or other memory of the network interface PHY 512. The queues 526 can be instantiated, updated, monitored, or controlled by a core 528 of a processor associated with the data processing system 500. For example, a core 528 of a processor assigned to or associated with an ADC cluster 502 or ADC manager 504 of the data processing system 500.

The data processing system 500 can include at least one application delivery controller (ADC) cluster 502. An ADC can be any resource of the cluster, which can be hosted by a container. An ADC cluster 502 can include an aggregation of containers. One or more containers can be configured to execute one or more functions. The containers of an ADC cluster 502 can include multiple instances of a same or similar resource, or instances of different resources. For example, the ADC cluster 502 can include one or more authentication resources, one or more file transfer services, or one or more network routing resources. Each container of the cluster can be assigned network 104, software, or hardware resources. For example, the container can include a memory space separate from other containers of the cluster, and virtualized or pass through hardware resources including storage, I/O (e.g., fractional or complete ports), or event log 524 access.

The data processing system 500 can include at least one ADC manager 504. The ADC manager 504 can be designed, constructed and operational to maintain a cluster of containers in a user space 516 of the data processing system 500 that is different from a kernel space 518 of the data processing system 500. For example, the ADC manager 504 can instantiate, monitor, terminate, or otherwise manage one or more ADC clusters 502 of containers. For example, the ADC manager 504 can assign hardware resources of a host to the ADC cluster 502 (e.g., to a container thereof). For example, the ADC manager 504 can assign one or more processors or processor cores 528 of a host device to an ADC cluster 502. The ADC manager 504 can assign a same or different number of cores 528 to various containers of an ADC cluster 502. For example, the ADC manager 504 can assign a same or different number of cores 528 to multiple instances of a same container resource or according to a container resource type. For example, the ADC manager 504 can assign a lower number of cores 528 relative to an assigned memory for a memory-bound resource of a cluster.

The ADC manager 504 can reside on a same host platform as the managed ADC clusters 502. The ADC manager 504 can consume one or more resources of the host platform. For example, the ADC manager 504 can consume a one or more processor cores 528, memory, or network resources of the host machine. For example, the ADC manager 504 can consume a same or different network connection type as one or more of the containers (e.g., can receive packets via kernel space 518 or user space 516). The ADC manager 504 can communicate with various ADC clusters 502, containers or other resources by an internal bridge network 104. For example, the internal bridge network 104 can be a Peripheral Component Interconnect Express (PCIe) network 104, an Ethernet network 104, or another network 104. The internal bridge network 104 (e.g., a sideband network) can be masked, firewalled, isolated, or otherwise not be directly accessible via a public network 104.

The ADC manager 504 can access the configuration file 522 to manage the containers, and can cause events to be stored in the event log 524. For example, the ADC manager 504 can cause event log 524 storage of events of the host device (e.g., startup time, errors, or network connections) or the ADC clusters 502 (e.g., instantiations of clusters or containers, removals of clusters or containers, or errors). The ADC manager 504 can remove or otherwise cause removal a container from the ADC cluster 502. For example, the ADC manager 504 can remove a container responsive to a detected error, or responsive to an indication to remove a container from the scaling daemon 510. The ADC manager 504 can determine whether a host system (e.g., a host system comprising one or more components of the data processing system 500) contains a number of cores 528 in excess of a threshold. For example, a host system having eight available or total cores 528 can be beneath a threshold, such that the ADC manager 504 can determine that various containers or resources can be natively hosted (e.g., may not instantiate a cluster of containers). A host system having 256 cores 528 can be above a threshold such that the ADC manager 504 can instantiate clusters of containers (e.g., based on a threshold of twenty-eight, thirty-two, or fifty six cores 528). The ADC manager 504 can invoke (e.g., instantiate, call, or address) a scaling daemon 510 responsive to the determination of the cores 528 above a threshold. For example, the ADC manager 504 can determine that the scaling daemon 510 can support a number of cores 528 or threads operated by a resource such as a cluster or a virtual function, or a maximum number of containers.

The data processing system 500 can include at least one virtual function daemon 506. The virtual function daemon 506 can interface with, be instantiated by, or be a part of the ADC manager 504. Where used herein, references to instantiations can be substituted by any other invocation, such as a call or another addressing of a component. The virtual function daemon 506 can execute in the user space 516 of the host device. The virtual function daemon 506 can receive attributes of one or more network interface cards of the host device. The virtual function daemon 506 can split the network card of the host device into multiple virtual functions. The virtual function daemon 506 can associate (e.g., assign or attach) each virtual function with a container of an ADC cluster 502. For example, the virtual function daemon 506 can allocate a portion of a memory map for each container of the cluster, and further define multiple queues 526 for each virtual function, each of the queues 526 being addressable by a separate core 528.

The data processing system 500 can include at least one load balancer 508. The load balancer 508 can interface with, be instantiated by, or be a part of the ADC manager 504. The load balancer 508 can balance a load between ADC clusters 502 or containers thereof. For example, the load balancer 508 can be instantiated on an ADC cluster 502 basis, a host basis, or another basis. The load balancer 508 can forward a packet according to a load balancing technique. For example, the load balancer 508 can forward a packet according to a content of the packet, a source region, a state of an ADC cluster 502 or container, or a predefined sequence such as a rotation between ADC clusters 502 or containers, or a random or pseudo-random sequence. The state of the ADC cluster 502 can include a memory usage, a CPU usage, or another state of a usage of a core 528 associated with the ADC cluster or a container thereof.

The data processing system 500 can include at least one scaling daemon 510. The scaling daemon 510 can interface with, be instantiated by, or be a part of the ADC manager 504. The scaling daemon 510 can receive parameters of a configuration file 522. For example, the scaling daemon 510 can receive a number of available cores 528 of a system. The number of available cores 528 of a system can be less than a total number of cores 528 of a system. For example, one or more cores 528 can be reserved for the ADC manager 504, a technical support device 514, or further ADC clusters 502 of the data processing system 500. The scaling daemon 510 can instantiate one or more clusters based on the determination. The scaling daemon 510 or other component of the data processing system 500 such as the ADC manager 504 can determine a number of cores 528 exceeds a threshold. For example, the threshold can be 28 or 32. The scaling daemon 510 can establish a predetermined number of containers for each of a plurality of virtual functions. The predetermined number of containers can be defined by the configuration file. For example, the scaling daemon 510 can instantiate a cluster having four containers, which may each be assigned, for example, sixteen cores 528. The scaling daemon 510 can cause the instantiation to be recorded in the event log 524.

The scaling daemon 510 can increase the number of containers responsive to an operating condition of the containers (e.g., CPU usage, memory usage, or another performance associated parameter). The scaling daemon 510 can cause the increase of containers to be recorded in the event log 524. The scaling daemon 510 can track a number of available processors, such as based on the configuration file 522 or in conjunction with additional scaling daemons 510 associated with further ADC clusters 502 of the data processing system 500. If an operating condition of the containers (e.g., a CPU usage) indicates additional containers should be instantiated, but a number of cores 528 required to instantiate the containers exceeds the number of available cores 528, the scaling daemon 510 can indicate that additional cores 528 or data processing systems 500 may be utilized. For example, the scaling daemon 510 can cause an indication to be stored by the event log 524, or convey an indication to the technical support device 514. The scaling daemon 510 can reduce a number of containers according to an operating condition of the ADC cluster 502. The reduction and increases of the containers can be asymmetric (e.g., can increase or decrease by a different number or at a different operating condition). The scaling daemon 510 can increase or reduce containers having a fixed number of threads, or can scale a core count of a container. For example, a container can be scaled between one and sixteen cores 528.

The scaling daemon 510 can identify a configuration file 522 (e.g., a configuration file 522 established for a host device of the data processing system). The configuration file 122 can include an auto-scale factor to define a number of containers to instantiate or remove. The containers can include a variable or pre-defined number of cores 528 that the data processing system assigns thereto. The configuration file 122 can include a scale up threshold defining a processor load at which additional containers are instantiated. The configuration file 122 can include a scale down threshold defining a processor load at which containers are removed. The scaling daemon 510 can identify a utilization of a first plurality of cores 528 managed by a plurality of virtual functions. For example, the utilization can describe an availability of one or more resources of the core 528. The data processing system 500 can include at least one technical support device 514. The technical support device 514 can share one or more components with the ADC cluster 502 (e.g., CPU or storage devices), or can be remote from the ADC cluster 502. For example, the ADC cluster 502 can be physically or electrically isolated from the technical support device 514 such that an error of the ADC cluster 502 caused by or associated with a device hosting the ADC cluster 502 can be detected by the technical support device (e.g., via an inactivity or failure to service a watchdog of the ADC cluster 502 or ADC manager 504). The technical support device 514 can store one or more profiles for a host device or the ADC clusters or containers thereof. For example, the technical support device can store a function, address, identifier, or state of the host device, ADC cluster, or containers.

The technical support device 514 can be communicatively coupled to one or more host devices such that the technical support device 514 can migrate a profile between devices responsive to a detection of an error. The technical support device 514 can receive, analyze or store error information in an event log 524 associated with one or more host device, containers, resource types, or the like. The technical support device 514 can command or manage a restart of a container, ADC cluster 502, or host, or may replace one or more missing or nonconforming files. For example, the technical support device 514 can replace a configuration file, a driver, or reimage a host device.

The data processing system 500 can include at least one network interface PHY 512, such as a network interface card. The network interface PHY 512 can include, but is not limited to, physical layer devices for the transmission of signals, such as magnetics or transceivers. For example, the network interface PHY 512 can include buffers, media dependent or media independent interfaces, control circuits, or other components, including further components of a network card. The network interface PHY 512 can include one or more network interface ports (e.g., Ethernet ports such as Gigabit Ethernet (“GbE”), 2.5 GbE, 10 GbE, 40 GbE, 100 GbE, 200 GbE, 400 GbE, and the like). The network interface PHY 512 can include one or more local device interfaces. For example, a network interface PHY 512 can include one or more memory mapped interfaces, such as a PCIe connection to interface with other components of the data processing system 500. The memory map of the network interface PHY 512 can include areas dedicated to one or more virtual functions such that a network interface card can communicate with various containers via the respective virtual interfaces (e.g., the network interface PHY 512 can appear as a network interface PHY 512 for each of the containers). The memory map can include or interface with multiple queues 526 for one or more virtual interfaces. For example, each queue 526 can attach to or be accessible by a core 528 of a container. The network interface PHY 512 can transmit queued items in a sequence such as by a round robin schedule, a priority based schedule, a first in last out or first in first out schedule, or may transmit items based on an available queue depth (e.g., to avoid queue overruns). In some embodiments, the ADC clusters 502, ADC manager 504, or another portion of the data processing system can manage (e.g., interleave) the queues 526.

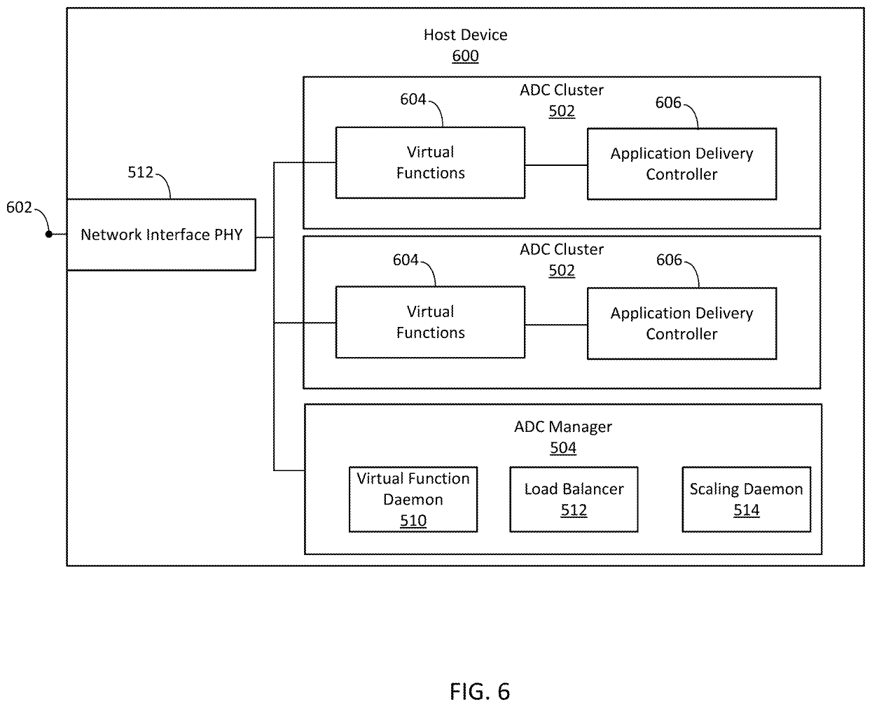

FIG. 6 is a block diagram of a host device 600, in accordance with an illustrative embodiment. The host device 600 can be a server appliance such as a server appliance having one or more processors including multiple cores 528. The host device 600 can include one or more components of the data processing system 500. A data processing system 500 can include one or more host devices. For example, the data processing system 500 can include various host devices 600 connected by the network 104. One or more of the cores 528 can be allocated to the ADC manager 504. For example, the ADC manager 504 can instantiate one more ADC clusters 502 of the host device. The ADC clusters 502 can be instantiated in response to an availability of a predefined number of cores 528 of the host device 600. For example, the host device 600 can include 256 cores 528. Each cluster of an ADC cluster 502 can access a network connection 602 via the network interface PHY 512. For example, ADCs 606 of each container can access the network connection 602 via a virtual function 604 of the container. The depicted ADCs 606 can be instantiated within a container. For example, the instantiation or reduction of ADCs 606 can include instantiating or terminating a container to host the ADC 606. The scaling daemon 510 can increase or decrease a number of ADCs 606 or associated containers.

In some implementations, the ADC manager 504 can consume four cores 528; each container can consume sixteen cores 528. Thus, a host device supporting one cluster can host fifteen ADCs 606, which can each consume one virtual function 604. Each virtual function 604 can include at least one queue 526 per core 528. For example, for a network interface PHY 512 having or supporting eight queues 526 per virtual function 604, two virtual functions 604 can be allocated to each ADC 606 or each ADC 606 can be assigned eight cores 528 (e.g., thirty-one ADCs 606 can be instantiated). The ADC manager 504 can manage multiple host devices 600. For example, the ADC manager 504 can instantiate multiple ADC clusters 502 across one or more devices responsive to a determination of an availability of a number of cores 528. Allocation of cores 528 can be static or dynamic.

A virtual function daemon 506 can associate (e.g., assign) virtual functions 604 to one or more (e.g., to each) ADC 606 of an ADC cluster 502. The virtual function daemon 506 can dissociate (e.g., release) the virtual function 404 when deactivating one or more of the ADC 606. For example, the scaling daemon 510 can reduce a number of ADCs 606 responsive to a low CPU load, or the ADC manager 504 can terminate an application delivery controller upon detecting an error condition. Upon the termination, the virtual function daemon 506 can release the virtual function 604 for association with another ADC 606. For example, the virtual function can be associated with an ADC 606 of an another ADC cluster 502 or an application delivery controller 606 which is restarted (e.g., immediately thereafter or upon an increase in the number of ADCs according to a configuration of the scaling daemon 510).

The virtual function daemon 506 can associate (e.g., assign) virtual functions 604 to further elements of the host device 600. For example, the virtual function daemon 506 can assign virtual functions 604 to the ADC manager 504 such that the ADC manager 504 can communicate with a technical support device 514 (not depicted) which may be remote from the host device 600 via the virtual function 604. The ADC manager 504 can communicate via a same or different network interface PHY 512 as the ADC clusters 502. For example, the ADC manager 504 can communicate via a sideband connection such as a connection managed by the kernel space 518 of the host device (e.g., by an Ethernet or USB controller thereof).

A load balancer 508 of the ADC manager 504 or of each ADC cluster 502 can forward incoming packets to the various application delivery controllers 606 of a cluster according to a load balancing technique, such as those techniques described herein. For example, the load balancer 508 can balance a load between virtual functions 604 or ADC clusters 502 hosting a same resource type. The load balancer 508 can cause an indication of a load of the ADC 606, a ADC cluster 502, or the host device 600 to be stored, such as via the event log 524, which can cause inter-host device 600 load balancing or error analysis (e.g., by the technical support device 514). For example, a time-progressive increase in memory use which is not correlated with increased processor load can indicate a memory leak of a container.

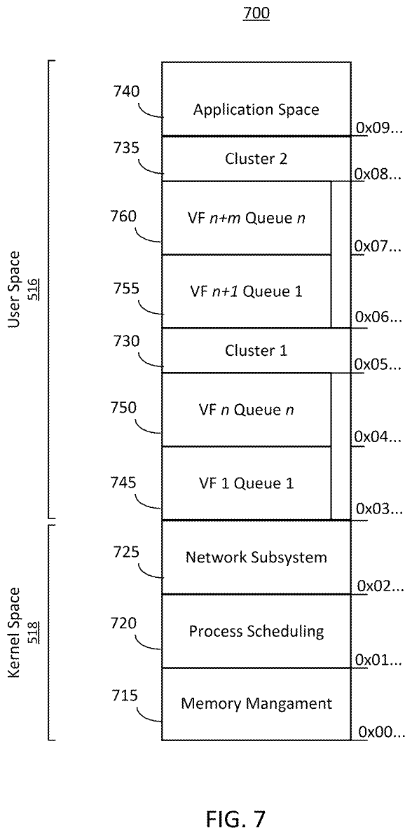

FIG. 7 is a memory map 700 for a host device 600 (e.g., the host device 600 of FIG. 6), in accordance with an illustrative embodiment. The memory map 700 can include kernel space 518 which may be inaccessible, protected, or otherwise abstracted from one or more cores of the data processing system 500. For example, the kernel space 518 can include a memory management subsystem 715 to correlate one or more physical memories or devices with an addressable memory location. The kernel space 518 can include system level memory space such as for process scheduling 720 or other functions to boot, instantiate, monitor, or otherwise manage the ADC cluster 502 or manager 504. The kernel space 518 can include a network subsystem 725. The network subsystem 725 can be associated with system limitations such as a number of thread handles, which may result in a throughput limit for one or more host devices 600. Put differently, the network subsystem 725 can bottleneck system performance such that it may be desirable to substitute or supplement the network subsystem 725 with another interface for a network interface PHY 512. The kernel space 518 can include the resources of the kernel space of FIG. 2.

The memory map can include user space 516 which can be accessible to one or more cores 528 of a container of the host device 600. For example, the user space 516 can include a first cluster 730. Some host devices can include a second cluster 735, a third cluster (not depicted), and so on. Each cluster can be accessible by one or more processor cores 528 to execute a function. For example, the first cluster 730 can be accessible by processor cores 528 of a first ADC cluster 502. The cluster memory space can include various memory ranges for the functions or overhead of the container. The cluster memory space can include further memory management, or other systems to avoid contention between the various cores 528 thereof. A memory space corresponding to a virtual function 604 of each ADC 606 of the cluster can be defined, and further subdivided according to a number of processor cores 528 of each ADC 606 such that each processor core 528 can access a distinct portion of memory (e.g., a distinct portion of a PCIe memory map corresponding to the network interface PHY 512). For example, a first core 528 of a cluster can access a first queue 745 of a first virtual function 604, a second core 528 can access a second queue, and an nth core 528 can access an nth queue. An nth queue 750 of the nth virtual function 604 can be assigned to another core 528.

The second cluster 735 memory space can include a same or different number of queues. Put differently, the first queue 755 of the n+1 virtual function 604 through the last queue 760 of the last virtual function 604 can include fewer or additional cores 528 relative to the first cluster. The second cluster can be omitted, such that each host device 600 hosts one cluster of containers.

The depicted memory locations are not intended to be limiting. For example, additional (e.g., of the application space 740, or the resources of the user space of FIG. 2) or fewer memory locations can be provided (e.g., for additional or fewer clusters, application spaces, or queues), or some memory locations can be non-contiguous or otherwise differently arranged. The selected memory addresses are arbitrary. For example, some processors or cores 528 can have limited access to one or more locations. For example, a core 528 of each respective cluster can access the cluster memory at a same address (e.g., 0x00) and the memory space may be inaccessible to other processors.

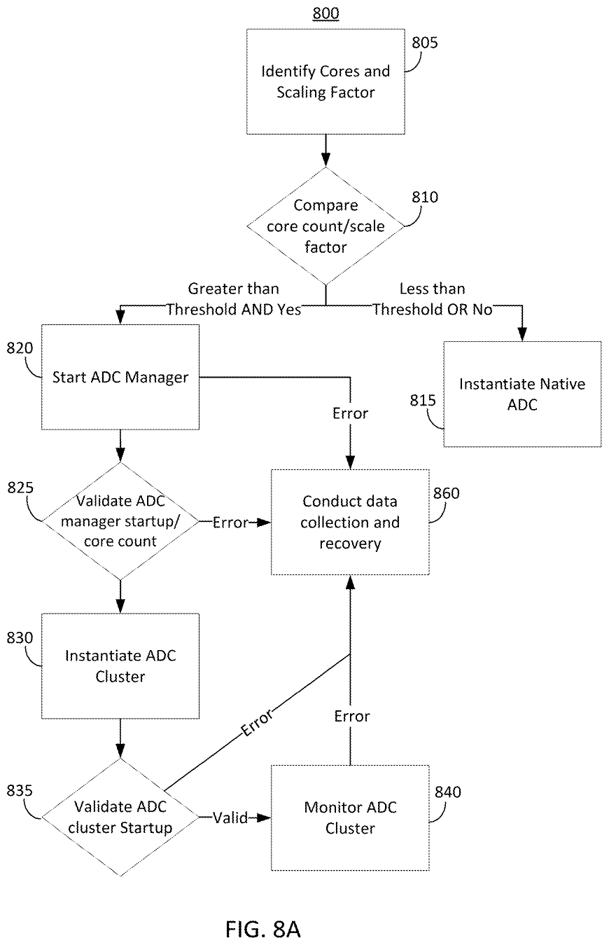

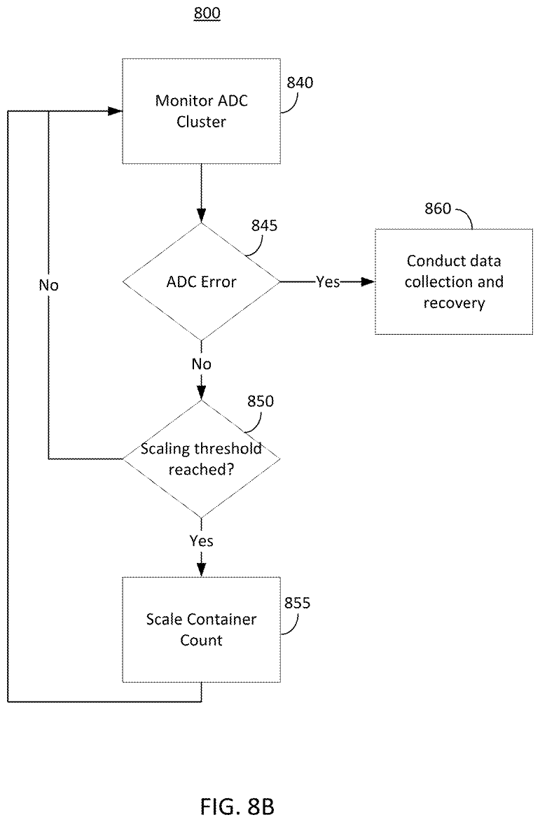

FIG. 8A is a first portion of a flow diagram of a method 800 for autoscaling user space network stacks, in accordance with an illustrative embodiment. In brief summary, the method includes operation 805, at which the data processing system 500 identifies a number of cores 528 and a scaling factor. At operation 810, the data processing system 500 compares the number of cores 528 to a threshold or evaluates a presence of a scale factor. At operation 815, the data processing system instantiates a native ADC. At operation 820, the data processing system 500 starts an ADC manager 504. At operation 825, a startup of the ADC manager 504 or a core 528 count of a system is validated. At operation 830, an ADC cluster 502 is instantiated. At operation 835, a startup of the ADC cluster 502 is validated. At operation 840, the ADC cluster 502 is monitored, such as during operation. At operation 845, an ADC error condition is detected. At operation 850, a scaling threshold is detected. At operation 855, a container count is scaled (e.g., upwards or downwards). At operation 860, the data processing system 500 performs data collection and recovery.

At operation 805, the data processing system 500 identifies a number of cores 528 and a scaling factor. For example, the core 528 count can be a total number of cores 528 of a device. The core count can be a number less than a number of cores 528 present in a device. For example, the core count can be defined by a configuration file 522. At operation 810, the data processing system 500 compares the number of cores 528 to a threshold or evaluates a presence of a scale factor. If a number of cores 528 is less than the threshold, the method can proceed to operation 815. The threshold can be determined according to a scalability of a resource such as a load balancer 508. For example, the threshold number of cores 528 can be 28. The data processing system 500 can also determine the presence of a scaling factor at operation 810. If a scaling factor is absent, the method can proceed to operation 815. If the number of cores 528 is greater than the threshold and a scaling factor is present, the method can proceed to operation 820.

At operation 815, the data processing system instantiates a native ADC. For example, the native ADC can instantiate ADCs natively, or according to one or more containers, each container associated with (e.g., assigned) a native network interface PHY 512.

At operation 820, the data processing system 500 starts an ADC manager 504. The ADC manager 504 can be started responsive to a determination that a number of cores 528 exceeds the threshold or that a scaling factor is provided. For example, if a scaling factor is not provided, the method can proceed to operation 815, or an ADC 606 can be started which does not include an active scaling daemon 510. At operation 825, a startup of the ADC manager 504 or a core count of a system is validated. For example, the method can proceed to operation 860 responsive to a failure of the ADC manager 504 to startup. The method can proceed to operation 860 responsive to an available number of cores 528. For example, if a number of available cores 528 is less than a required number of cores 528 (e.g., a product of the number of virtual functions 604 and the number of queues 526 per virtual function 604), the method can proceed to operation 860.

At operation 830, an ADC cluster 502 is instantiated. For example, the ADC manager 504 can instantiate an ADC cluster 502 having a number of containers defined by a scaling factor of a configuration file 522. The number of containers can be a same or different number of containers of a scale up or scale down factor which can be defined according to the configuration file 522. At operation 835, a startup of the ADC cluster 502 is validated. For example, the validation can include validating one or more clusters' receipt of a packet, performance of a task, or conveyance of a different packet, such as a conveyance to a queue 526 of a virtual function 604 associated with the container. The validation can include an indication of initialization completion such as a message of the end of a startup script for the container. The indication can be an initial or a periodic indication such as a watchdog or heartbeat. Responsive to a failure to validate one or more containers of the ADC cluster 502, an ADC 606 thereof, or another portion of the ADC cluster 502 (e.g., a load balancer 508), the method can proceed to operation 860. Responsive to a validation of the startup of the ADC cluster 502, the method can proceed to operation 840.

Referring now to FIG. 8B, a second portion of the method 800 for autoscaling user space network stacks is depicted, in accordance with an illustrative embodiment. At operation 840, the ADC cluster 502 is monitored, such as by an ADC manager 504. The ADC manager can monitor or perform one or more operations of validating the startup of the ADC cluster 502, such as a heartbeat, watchdog, performance of a task, or the receipt or conveyance of a packet. The monitoring of the ADC cluster 502 can include a performance metric of one or more containers. For example, the ADC manager 504 can monitor a latency, throughput, error rate, or other metric. The ADC manager 504 can cause the metric to be recorded on an event log 524. The ADC manager 504 can determine an error based on a performance metric meeting a threshold, which can include a time average, a success/failure count, or the like. Upon detection of an error (e.g., operation 845), the method can proceed to operation 860. The monitoring of the ADC cluster 502 can include monitoring a performance component of the ADC cluster 502 relative to one or more scaling factors. For example, the ADC manager 504 can monitor the CPU load of an ADC cluster 502. At operation 850, the ADC manager can determine a scaling threshold has been met. Upon detection of a performance metric indicating a scaling, such as an increase of a number of containers or a decrease of a number of containers, the method can proceed to operation 855.

At operation 855, a container count is scaled (e.g., upwards or downwards). For example, an ADC manager 504 (e.g., a scaling daemon 510 thereof) can compare a number of containers of an ADC cluster 502 to a maximum or minimum number of containers. If the number of containers is equal to the maximum or minimum number of containers, the ADC manager 504 can cause an indication of the maximum or minimum being reached to be recorded on the event log 524 or can cause an instantiation of an additional ADC cluster 502 or container thereof (e.g., on a same or different host device 600). The ADC manager 504 can validate an instantiation or termination of the containers or ADC clusters 502. For example, the ADC manager can perform one or more validation checks for instantiating the ADC cluster at operation 835.

At operation 860, the data processing system 500 performs data collection and recovery. For example, a technical support device 514 can receive an indication of the error. For example, the technical support device can monitor an event log 524, can monitor an ADC cluster 502 or host device 600, or can receive an indication of the error (e.g., from a host device 600, incident to the error of the container, ADC cluster 502, ADC manager 504, or other portion of the data processing system 500. The technical support device 514 can receive, log, categorize, or process information related to the errors such as a performance of the container, ADC cluster 502, ADC manager 504, or host device 600 proximate to the error, an error type, error time, or any other information received by the technical support device 514. The technical support device 514 can cause a container ADC cluster 502, ADC manager 504, or host device 600 to restart. For example, the technical support device can receive information defining the state of the data processing system 500 and can re-instantiate the various components on a same or different host device 600. The re-instantiation can include one or more retries, or can determine one or more hardware failures of a data processing system. According to some implementations, the technical support device 514 can restore a device to a functional state at or immediately prior to a failure.

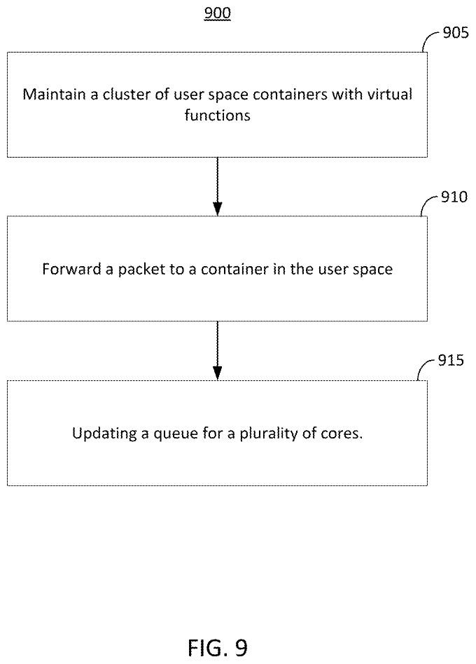

FIG. 9 is another flow diagram of a method 900 for autoscaling user space network stacks, according to an illustrative embodiment. At operation 905, an ADC cluster 502 is maintained on a host device 600. The ADC cluster 502 can include multiple clustered containers. Each container can include, interface with, or implement a virtual function 604 corresponding to a network interface PHY 512. packets are forwarded to a container of the user space 516 according to a load balancing technique. The virtual functions can be accessible to multiple cores 528, in a user space 516 of a system, separate from the memory space of the kernel (e.g., according to a memory management subsystem 715, such as a memory management subsystem 715 of an operating system including a *nix operating system). The ADC cluster 502 can include, attach to, or interface with a user space 516 driver to send or receive Ethernet packets which bypass kernel space (e.g., are not routed by a network driver residing in kernel space 518).

At operation 910, a load balancer 508 of the host device 600 forwards a packet received by the device to a container of the cluster of containers in the user space 516 that executes (includes, interfaces with, or implements) a virtual function 604. For example, the load balancer 508 can forward packets to a container having a lowest load or latency, or can forward the packet to a container according to a predefined schedule such as a round robin or other pre-defined distribution. The load balancer 508 can receive an indication that a container or an ADC 606 thereof is available to receive a packet, such as by a ready flag, an absence of a buffer full flag, or a performance metric determined by an ADC manager 504.

At operation 915, a queue 526 is updated for a plurality of cores 528. The queue 526 can be a memory space wherein a packet received by the network interface PHY 512 is conveyed to a memory location accessible to a core 528 of an ADC 606 of the container. For example, the queue 526 can be a PCIe memory mapped location. The core 528 can detect the presence of the updated queue 526 such as by polling the location, a ready bit associated with the location, an interrupt associated with the updating of the location or the like. The core 528 can process the packet according to a function of the ADC 606 of the container. For example, the core 528 can access a resource and cause a resource (e.g., a file, key, or an acknowledgement) to be conveyed the sender of the packet or another network location.

### F. Example Embodiments for Autoscaled User Space Networking Stacks

The following examples pertain to further example embodiments, from which permutations and configurations will be apparent.

Example 1 includes a system. The system includes one or more processors and a memory. The device is configured to maintain a cluster of containers in a user space separate from a kernel space of the device. Each container in the cluster of containers can execute a respective one of a plurality of virtual functions for a network interface card of the device. The network interface card can be configured to cause packets received by the device to bypass the kernel space. The device is configured to forward a packet via a load balancing technique. The packet can be received by the device to bypass the kernel space. The device is configured to update a queue for a core of the plurality of cores managed by the virtual function to cause the core to process the packet in accordance with the queue.

Example 2 includes the subject matter of Example 1, further comprising the device to identify a number of cores accessible to the device to process packets received by the device. The device is configured to determine, responsive to the number of cores greater than a threshold, to establish a predetermined number of containers for the plurality of virtual functions. The device is configured to configure, based on the number of cores, each of the plurality of virtual functions with a predetermined number of queues. Each queue of the predetermined number of queues can map to a core of the plurality of cores.

Example 3 includes the subject matter of examples 1 or 2 wherein the device is further configured to identify a configuration file established for the device. The configuration file can include an indication of a number of cores of the device, an auto-scale factor, a scale-up threshold, and a scale down threshold.

Example 4 includes the subject matter of any of examples 1 to 3, wherein the system includes a daemon executed by the device in the user space. The daemon can split the network interface card of the device into the plurality of virtual functions. The daemon can configure a plurality of containers of the cluster of containers with a respective one of the plurality of virtual functions to cause packets received by the device to bypass the kernel space and be processed by at least one of the plurality of virtual functions configured in the plurality of containers.

Example 5 includes the subject matter of any of examples 1 to 4, wherein the device is configured to identify, in a configuration file established for the device, a number of cores accessible to the device and an indication to auto-scale. The device is configured to invoke, responsive to the indication to auto-scale and the number of cores greater than a threshold, the daemon.

Example 6 includes the subject matter of any of examples 1 to 5, wherein the device is configured to invoke, responsive to one or more parameters indicated in a configuration file established for the device, a daemon. The daemon can be configured to determine a number of virtual functions operable with the network interface card of the device, a number of threads operable by each virtual function, and a maximum number of containers operable within the cluster of containers. The device can be configured to determine a number of cores the daemon is capable to support based on the number of virtual functions, the number of threads, and the maximum number of containers. The device can be configured to establish, based on a comparison of the determined number of cores the daemon is capable to support with a number of cores accessible by the device, the cluster of containers.

Example 7 includes the subject matter of any of examples 1 to 6, wherein containers within the cluster of containers communicate via an internal bridge network that is not directly accessible via a public network. The device can be further configured to assign an internet protocol address to the cluster of containers.

Example 8 includes the subject matter of any of examples 1 to 7, wherein the device is configured to identify a utilization of a first plurality of cores managed by the plurality of virtual functions. The device can determine, responsive to the utilization greater than or equal to a threshold, to upscale the cluster of containers. The device can invoke, responsive to the determination to upscale the cluster of containers, an additional container with an additional virtual function for an additional core of the plurality of cores. The device can add the additional container to the cluster of containers.

Example 9 includes the subject matter of any of examples 1 to 8, wherein the device is configured to identify a utilization of the plurality of cores managed by the plurality of virtual functions. The device can determine, responsive to the utilization less than or equal to a threshold, to downscale the cluster of containers. The device can cause removal of at least one container from the cluster of containers to reduce a number of containers in the cluster of containers.

Example 10 includes the subject matter of any of examples 1 to 9, wherein the device is configured to detect an error associated with the container or the virtual function in the cluster of containers. The device can replace, responsive to detection of the error, the container with a new container and a new virtual function to manage the core.

Example 11 includes the subject matter of any of examples 1 to 10, wherein the device is configured to detect an error associated with the container or the virtual function in the cluster of containers. The device can include the error in a log for the container. The device can provide the log to a technical support device remote from the device.

Example 12 includes the subject matter of any of examples 1 to 11, wherein the device is configured to store, in a log, an indication of an error associated with the container or the virtual function in the cluster of containers. The device can provide the log to a technical support device remote from the device. The device can cause, responsive to the error and subsequent to provision of the log to the technical support device, removal of the container from the cluster of containers.

Example 13 includes a method. The method includes maintaining, by a device comprising a plurality of cores and memory, a cluster of containers in a user space separate from a kernel space of the device. Each container in the cluster of containers can execute a respective one of a plurality of virtual functions, for a network interface card of the device, configured to cause packets received by the device to bypass the kernel space. The method includes forwarding, by the device via a load balancing technique, a packet received by the device to a container in the cluster of containers in the user space that executes a virtual function of the plurality of virtual functions. The method includes updating, by the device, a queue for a core of the plurality of cores managed by the virtual function to cause the core to process the packet in accordance with the queue.

Example 14 includes the subject matter of Example 13, wherein the method includes identifying, by the device, a number of cores accessible to the device to process packets received by the device. The method includes determining, by the device, responsive to the number of cores greater than a threshold, to establish a predetermined number of containers for the plurality of virtual functions. The method includes configuring, by the device based on the number of cores, each of the plurality of virtual functions with a predetermined number of queues. Each queue of the predetermined number of queues can map to a core of the plurality of cores.

Example 15 includes the subject matter of Example 13 or 14, wherein the method includes identifying, by the device, a configuration file established for the device, the configuration file. The configuration file can include an indication of a number of cores of the device, an auto-scale factor, a scale-up threshold, and a scale down threshold.

Example 16 includes the subject matter of any of examples 13 to 15, the method includes splitting, by a daemon executed by the device in the user space, the network interface card of the device into the plurality of virtual functions. The method includes configuring, by the daemon, a plurality of containers of the cluster of containers with a respective one of the plurality of virtual functions to cause packets received by the device to bypass the kernel space and be processed by at least one of the plurality of virtual functions configured in the plurality of containers.

Example 17 includes the subject matter of any of examples 13 to 16, the method includes identifying, in a configuration file established for the device, a number of cores accessible to the device and an indication to auto-scale. The method includes invoking, responsive to the indication to auto-scale and the number of cores greater than a threshold, the daemon.

Example 18 includes the subject matter of any of examples 13 to 17, the method includes invoking, by the device responsive to one or more parameters indicated in a configuration file established for the device, a daemon configured to determine a number of virtual functions operable with the network interface card of the device, a number of threads operable by each virtual function, and a maximum number of containers operable within the cluster of containers. The method includes determining, by the device, a number of cores the daemon is capable to support based on the number of virtual functions, the number of threads, and the maximum number of containers. The method includes establishing, by the device, based on a comparison of the determined number of cores the daemon is capable to support with a number of cores accessible by the device, the cluster of containers.

Example 19 includes a non-transitory computer readable medium storing instructions that, when executed by one or more processors, cause the one or more processors to maintain a cluster of containers in a user space separate from a kernel space of a device. Each container in the cluster of containers can execute a respective one of a plurality of virtual functions, for a network interface card of the device, configured to cause packets received by the device to bypass the kernel space. The instructions further cause the one or more processors to forward, via a load balancing technique, a packet received by the device to a container in the cluster of containers in the user space that executes a virtual function of the plurality of virtual functions. The instructions further cause the one or more processors to update a queue for a processor managed by the virtual function to cause the processor to process the packet in accordance with the queue.

Example 20 includes the subject matter of Example 19, wherein the instructions further comprise instructions to identify a number of processors accessible to the device to process packets received by the device. The instructions can further comprise instructions to determine, responsive to the number of processors greater than a threshold, to establish a predetermined number of containers for the plurality of virtual functions. The instructions can further comprise instructions to configure, based on the number of cores, each of the plurality of virtual functions with a predetermined number of queues. Each queue of the predetermined number of queues can map to a processor of the number of processors.

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus, or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C #, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents. References to “or” can be construed as inclusive so that any terms described using “or” can indicate any of a single, more than one, and all of the described terms. For example, a reference to “at least one of ‘A’ and ‘B‘” can include only “A,” only “B,” as well as both “A” and “B.” Such references used in conjunction with “comprising” or other open terminology can include additional items.

It will be further understood that various changes in the details, materials, and arrangements of the parts that have been described and illustrated herein may be made by those skilled in the art without departing from the scope of the following claims.

We claim:

1. A system, comprising:
a device comprising a plurality of cores and memory to:
maintain a cluster of containers in a user space separate from a kernel space of the device, each container in the cluster of containers to execute a respective one of a plurality of virtual functions, for a network interface card of the device, configured to cause packets received by the device to bypass the kernel space;
forward, via a load balancing technique, a packet received by the device to a container in the cluster of containers in the user space that executes a virtual function of the plurality of virtual functions; and
update a queue for a core of the plurality of cores managed by the virtual function to cause the core to process the packet in accordance with the queue.

2. The system of claim 1, wherein the device is further configured to:
identify a number of cores accessible to the device to process packets received by the device;
determine, responsive to the number of cores greater than a threshold, to establish a predetermined number of containers for the plurality of virtual functions; and
configure, based on the number of cores, each of the plurality of virtual functions with a predetermined number of queues, wherein each queue of the predetermined number of queues maps to a core of the plurality of cores.

3. The system of claim 1, wherein the device is further configured to:
identify a configuration file established for the device, the configuration file comprising an indication of a number of cores of the device, an auto-scale factor, a scale-up threshold, and a scale down threshold.

4. The system of claim 1, comprising:
a daemon executed by the device in the user space, the daemon configured to:
split the network interface card of the device into the plurality of virtual functions; and
configure a plurality of containers of the cluster of containers with a respective one of the plurality of virtual functions to cause packets received by the device to bypass the kernel space and be processed by at least one of the plurality of virtual functions configured in the plurality of containers.

5. The system of claim 4, wherein the device is further configured to:
identify, in a configuration file established for the device, a number of cores accessible to the device and an indication to auto-scale; and
invoke, responsive to the indication to auto-scale and the number of cores greater than a threshold, the daemon.

6. The system of claim 1, wherein the device is further configured to:
invoke, responsive to one or more parameters indicated in a configuration file established for the device, a daemon configured to determine a number of virtual functions operable with the network interface card of the device, a number of threads operable by each virtual function, and a maximum number of containers operable within the cluster of containers;
determine a number of cores the daemon is capable to support based on the number of virtual functions, the number of threads, and the maximum number of containers; and
establish, based on a comparison of the determined number of cores the daemon is capable to support with a number of cores accessible by the device, the cluster of containers.

7. The system of claim 1, wherein containers within the cluster of containers communicate via an internal bridge network that is not directly accessible via a public network, and the device is further configured to assign an internet protocol address to the cluster of containers.

8. The system of claim 1, wherein the device is further configured to:
identify a utilization of a first plurality of cores managed by the plurality of virtual functions;
determine, responsive to the utilization greater than or equal to a threshold, to upscale the cluster of containers;
invoke, responsive to the determination to upscale the cluster of containers, an additional container with an additional virtual function for an additional core of the plurality of cores; and
add the additional container to the cluster of containers.

9. The system of claim 1, wherein the device is further configured to:
identify a utilization of the plurality of cores managed by the plurality of virtual functions;
determine, responsive to the utilization less than or equal to a threshold, to downscale the cluster of containers; and
cause removal of at least one container from the cluster of containers to reduce a number of containers in the cluster of containers.

10. The system of claim 1, wherein the device is further configured to:
detect an error associated with the container or the virtual function in the cluster of containers; and
replace, responsive to detection of the error, the container with a new container and a new virtual function to manage the core.

11. The system of claim 1, wherein the device is further configured to:
detect an error associated with the container or the virtual function in the cluster of containers;
include the error in a log for the container; and
provide the log to a technical support device remote from the device.

12. The system of claim 1, wherein the device is further configured to:
store, in a log, an indication of an error associated with the container or the virtual function in the cluster of containers;
provide the log to a technical support device remote from the device; and
cause, responsive to the error and subsequent to provision of the log to the technical support device, removal of the container from the cluster of containers.

13. A method, comprising:
maintaining, by a device comprising a plurality of cores and memory, a cluster of containers in a user space separate from a kernel space of the device, each container in the cluster of containers to execute a respective one of a plurality of virtual functions, for a network interface card of the device, configured to cause packets received by the device to bypass the kernel space;
forwarding, by the device via a load balancing technique, a packet received by the device to a container in the cluster of containers in the user space that executes a virtual function of the plurality of virtual functions; and
updating, by the device, a queue for a core of the plurality of cores managed by the virtual function to cause the core to process the packet in accordance with the queue.

14. The method of claim 13, comprising:
identifying, by the device, a number of cores accessible to the device to process packets received by the device;
determining, by the device, responsive to the number of cores greater than a threshold, to establish a predetermined number of containers for the plurality of virtual functions; and
configuring, by the device based on the number of cores, each of the plurality of virtual functions with a predetermined number of queues, where in each queue of the predetermined number of queues maps to a core of the plurality of cores.

15. The method of claim 13, comprising:
identifying, by the device, a configuration file established for the device, the configuration file comprising an indication of a number of cores of the device, an auto-scale factor, a scale-up threshold, and a scale down threshold.

16. The method of claim 13, comprising:
splitting, by a daemon executed by the device in the user space, the network interface card of the device into the plurality of virtual functions; and
configuring, by the daemon, a plurality of containers of the cluster of containers with a respective one of the plurality of virtual functions to cause packets received by the device to bypass the kernel space and be processed by at least one of the plurality of virtual functions configured in the plurality of containers.

17. The method of claim 16, comprising:
identifying, in a configuration file established for the device, a number of cores accessible to the device and an indication to auto-scale; and
invoking, responsive to the indication to auto-scale and the number of cores greater than a threshold, the daemon.

18. The method of claim 13, comprising:
invoking, by the device responsive to one or more parameters indicated in a configuration file established for the device, a daemon configured to determine a number of virtual functions operable with the network interface card of the device, a number of threads operable by each virtual function, and a maximum number of containers operable within the cluster of containers;
determining, by the device, a number of cores the daemon is capable to support based on the number of virtual functions, the number of threads, and the maximum number of containers; and
establishing, by the device, based on a comparison of the determined number of cores the daemon is capable to support with a number of cores accessible by the device, the cluster of containers.

19. A non-transitory computer-readable medium storing instructions that, when executed by one or more processors, cause the one or more processors to:
maintain a cluster of containers in a user space separate from a kernel space of a device, each container in the cluster of containers to execute a respective one of a plurality of virtual functions, for a network interface card of the device, configured to cause packets received by the device to bypass the kernel space;
forward, via a load balancing technique, a packet received by the device to a container in the cluster of containers in the user space that executes a virtual function of the plurality of virtual functions; and
update a queue for a processor managed by the virtual function to cause the processor to process the packet in accordance with the queue.

20. The computer-readable medium of claim 19, wherein the instructions further comprise instructions to:
identify a number of processors accessible to the device to process packets received by the device;
determine, responsive to the number of processors greater than a threshold, to establish a predetermined number of containers for the plurality of virtual functions; and
configure, based on the number of cores, each of the plurality of virtual functions with a predetermined number of queues, wherein each queue of the predetermined number of queues maps to a processor of the number of processors.
